(19) United States
(12) Patent Application Publication
(10) Pub. No.: US 2006/0250897 A1
(43) Pub. Date: Nov. 9, 2006

(54) Analog watch fiber optic image guide

(76) Inventor: Donald R. Brewer, Richardson, TX (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/263,451

(22) Filed: Oct. 31, 2005

Related U.S. Application Data
(63) Continuation-in-part of application No. 11/139,329, filed on May 27, 2005.
(60) Provisional application No. 60/677,506, filed on May 4, 2005.

(51) Int. Cl. G04C 19/00

(52) U.S. Cl. 368/82

(57) ABSTRACT

An analog watch includes an analog movement capable of providing at least time information indicated by at least two movement hands positioned over a watch dial. The analog watch further includes a fiber optic image guide having a taper extending from a bottom surface to a top surface. The bottom surface of the fiber optic image guide is optically coupled to the watch dial. The taper of the fiber optic image guide extends from the bottom surface to the top surface in such a manner that an image present at the watch dial is magnified for viewing at the top surface of the fiber optic image guide.

This application claims the benefit of U.S. Provisional Application Ser. No. 60/677,506 entitled “Watch Fiber Optic Image Guide” that was filed on May 4, 2005 and also claims the benefit of U.S. application Ser. No. 11/139,329 entitled “Watch Fiber Optic Image Guide” that was filed on May 27, 2005.

### BACKGROUND OF THE INVENTION

Currently there is a wide assortment of consumer electronic devices such as mobile phones, MP3 players, and wrist watches (particularly digital wrist watches) that include an informational display, such as a liquid crystal display (“LCD”), as the main visual interface to the device. In many such product applications the information display is a prominent design element. The proliferation of inexpensive consumer electronics has commoditized the appearance of a typical black on grey liquid crystal display, and even color active matrix displays are now found in a wide assortment of mobile phones. Many of these types of consumer electronic devices are substantially equivalent in both specifications and functions. Thus, manufacturers are constantly searching for new ways to differentiate the design and appearance of their device in any way from other products, particularly more inexpensive products.

Optical fibers are typically either glass or plastic optic threads that are capable of transmitting light along their length, preferably with minimal loss. Fiber optics are now commonly used both for data transmission as well as transmitting either light or image information. In some embodiments, the present-invention makes use of fiber optics for the ability to transmit light, particularly an image, using a coherent bundle of optical fibers that have been fused together on both ends. In 1926 Clarence Hansell outlined the basic principles on the use of a fiber-optic image bundle which was patented for RCA in the United States in 1927. It was Heinrich Lamm who first demonstrated image transmission through a bundle of optical fibers.

Fiber optic imaging elements are now common in the form of faceplates, tapers, and image guides (or conduits) that have been found in a number of high dollar value applications in the market place for more than 25 years. In some applications, a fiber optic face plate comprises thousands of glass fibers arranged parallel to one another in a coherent bundle, and fused together so that it is hermetically tight. Thus, the fiber optic faceplate can transfer an image from one plane to another plane. Some industrial applications use fused coherent fiber optics bundles for image transfer; such as in the fiber optics faceplates used on some cathode ray rubes (CRTs) to “flatten” the image presented to the user.

The use of fiber optic faceplates with information displays is described in U.S. Pat. No. 4,349,817 to Hoffman et al. with the use of a dynamic scattering liquid crystal display, as well as in U.S. Pat. No. 4,183,360 to Funada, U.S. Pat. No. 5,035,490 to Hubby, Jr. and U.S. Pat. No. 5,181,130 to Hubby, Jr. in combination with a liquid crystal display utilizing at least one polarizer, most typical of the type of liquid crystal displays found in consumer products today. In these early patents the fiber optic faceplate is used to transfer an image from the liquid crystal display image plane up to the outer plane of the fiber optic faceplate as much as 1.1 mm away. The overriding focus of the disclosures of these patents, however, is to improve the image quality of the underlying liquid crystal display by increasing the light incident on the liquid crystal display, removing the ghosting effects, and improving off-axis viewing. In these patents the fiber optic faceplate has planar and parallel top and bottom surfaces. The bottom surface of the fiber optic faceplate is in contact with the top surface of the information display. Alternatively, in some cases the fiber optic faceplate is actually one of the top substrates of the information display, and the outer top surface of the fiber optic faceplate is planar and parallel to the bottom surface.

Although discussed in the two patents to Hubby, Jr. filed approximately 15 years ago, fiber optic faceplates in combination with information displays have not been accepted in the market to any significant degree. This is at least in part due to market considerations wherein there is a tradeoff between price and acceptable display functionality. Although the image quality of liquid crystal displays can be improved as discussed in the patents to Hubby, Jr., the method discussed therein (which often involves replacing the top glass substrate layer with a fiber optic faceplate) is generally not considered commercially feasible due to the production techniques and materials. As taught, however, they offer little to no significant improvement in image quality that might justify the added cost of the external fiber optic faceplate.

Consumer product manufacturers often find that the negative display issues with liquid crystal displays, such as poor reflectance and limited off-axis viewing, are acceptable at the price level of said displays. As discussed in U.S. Pat. No. 4,183,630 to Funada et al., one could couple a fiber optic faceplate to the top surface of a conventionally made reflective liquid crystal display with top and bottom glass substrates and outer top and bottom polarizers, but such a configuration typically has less optical performance than if the fiber optic faceplate is actually the top substrate of the liquid crystal display itself. Since the optical performance of liquid crystal displays was a major issue through the late 1970's into the early 1990's, none of these early patents considered the potential overall design possibilities that are possible when the fiber optic image guides are used unconventionally with an information display.

The numerous information display technologies available in the market today generally present only a flat two-dimensional display format. Some patents detail the use of fiber optic faceplates coupled with cathode ray tube (CRT) displays to convert the typical curved CRT display output to a flat, planar display image. Visually this flat display appearance has become commoditized and, as mentioned previously, companies are seeking new ways to differentiate the design of their products. The disclosure found in U.S. Pat. No. 5,035,490 to Hubby, Jr. or U.S. Pat. No. 5,181,130 to Hubby, Jr. provide no real advantage in differentiating the design or appearance of the informational display to an end user. This appears to be true despite the fact that there are literally billions of consumer products featuring liquid crystal displays made each year of either the twisted nematic (TN), super-twist nematic (STN), or active matrix varieties.

### SUMMARY OF THE INVENTION

In one embodiment of the present invention there is disclosed an apparatus comprising a display capable of providing information at an external display surface. The apparatus further includes a fiber optic image guide with a bottom surface and a top surface. The bottom surface of the fiber optic image guide preferably being optically coupled to the external display surface. The top surface of the fiber optic image guide includes a first portion defining a first plane and a second portion defining a second plane that is different from the first plane.

In another embodiment of the present invention there is disclosed an apparatus comprising a display capable of providing information at an external display surface. The apparatus further includes a fiber optic image guide with a bottom surface and a top surface. The bottom surface of the fiber optic image guide preferably being optically coupled to the external display surface. The top surface of the fiber optic image guide includes a first portion offset from the bottom surface by a first height and a second portion offset from the bottom surface by a second height. The first height is different from the second height. The second portion of the top surface defines at least a part of a logo, preferably a three-dimensional logo.

In another embodiment of the present invention there is disclosed an apparatus comprising a display capable of providing information at an external display surface. The apparatus further includes a fiber optic image guide with a bottom surface and a top surface. The bottom surface of the fiber optic image guide preferably being optically coupled to the external display surface. The top surface includes at least one non-planar portion.

In another embodiment of the present invention there is disclosed an apparatus comprising a display capable of providing information at an external display surface. The apparatus further includes a fiber optic image guide with a bottom surface and a top surface. The bottom surface of the fiber optic image guide preferably being optically coupled to the external display surface. The top surface includes at least two planar surfaces spaced apart from the bottom surface by different amounts.

In another embodiment of the present invention there is disclosed an apparatus comprising a display capable of providing information at an external display surface. The apparatus further includes a fiber optic image guide with a bottom surface and a top surface. The bottom surface of the fiber optic image guide preferably being optically coupled to the external display surface. The top surface preferably does not define a single plane (single meaning one and only plane).

In another embodiment of the present invention there is disclosed a consumer electronic device comprising a display capable of providing information at an external display surface. The apparatus further includes a fiber optic image guide with a bottom surface and a top surface. The bottom surface of the fiber optic image guide preferably being optically coupled to the external display surface. The bottom surface of the fiber optic image guide is preferably spaced apart from the external display surface to define a cavity therebetween. The bottom surface of the fiber optic image guide is preferably offset from the external display surface by a distance greater then 0.1 mm.

In another embodiment of the present invention there is disclosed a digital watch comprising an information display capable of providing information at an external display surface and a fiber optic image guide having a taper. The information display is electrically connected to a power source, preferably a battery. The taper of the fiber optic image guide extends from a bottom surface to a top surface of the fiber optic image guide. The bottom surface of the fiber optic image guide is at least optically coupled to the external display surface of the information display. The taper of the fiber optic image guide extends from the bottom surface to the top surface in such a manner that an image present at the external display surface of the information display is either magnified or minimized, depending on taper orientation, for viewing at the top surface of the fiber optic image guide.

In another embodiment of the present invention there is disclosed a digital watch comprising an information display (preferably a liquid crystal display) capable of providing at least time information at an external display surface. The information display is connected to a power source, preferably a battery. The digital watch further comprises a fiber optic image guide having a first end and a second end. The first end of the fiber optic image guide is optically coupled to the external display surface of the information display. The watch further comprises a watch case having an interior surface and an exterior surface. The interior surface of the watch case defines an interior cavity. Moreover, the information display and at least a portion of the power source are positioned within the interior cavity. The watch case engages at least a portion of the fiber optic image guide so as to provide water resistance.

In another embodiment of the present invention there is disclosed a digital watch comprising an information display capable of providing at least time information at an external display surface. The information display is connected to a power source, preferably a battery. The watch further includes a fiber optic image guide having an entrance window and an exit window. The exit window of the fiber optic image guide defines an outer surface that does not lie within a single plane. The watch also includes a watch case connected to the information display and connected to the fiber optic image guide. The watch case retains the information display and the fiber optic image guide in positions such that the entrance window of the fiber optic image guide is optically coupled to the external display surface of the information display.

In another embodiment of the present invention there is a digital watch that includes an information display capable of providing at least time information at an external display surface. The information display is electrically connected to a power source, preferably a battery. The digital watch also includes a fiber optic image guide with a fused bottom surface (entrance image plane) and a fused top surface (exit image plane) with an intermediate flexible optical fiber region. The external display surface of the information display is optically coupled to the bottom surface of the fiber optic image guide. The intermediate flexible optical fiber region permits the watch face to be attached to and rotate with a rotatable ring on the watch case. The fiber optic image guide is preferably coupled to a bezel in such a manner as to provide some degree of water resistance. In one refinement, the watch further includes an objective lens that is optically coupled to the top surface of the fiber optic image guide to provide some magnification of the image.

In another embodiment of the present invention there is an analog watch includes an analog movement capable of providing at least time information indicated by at least two movement hands positioned over a watch dial. The analog watch further includes a fiber optic image guide having a taper extending from a bottom surface to a top surface. The bottom surface of the fiber optic image guide is optically coupled to the watch dial. The taper of the fiber optic image guide extends from the bottom surface to the top surface in such a manner that an image present at the watch dial is magnified for viewing at the top surface of the fiber optic image guide.

In another embodiment of the present invention there is an analog watch comprising an analog movement capable of providing at least time information indicated by at least two movement hands positioned over a watch dial. The analog watch further comprises a fiber optic image guide having a first end and a second end. The first end of the fiber optic image guide spaced apart from the movement hands. The analog watch further comprises a watch case including a wall having an interior surface and an exterior surface. The interior surface of the watch case defines an interior cavity. The analog movement and the watch dial are positioned substantially within the interior cavity.

In another embodiment of the present invention there is an analog watch comprising an analog movement capable of providing at least time information. The time information is preferably indicated by at least two movement hands positioned over an external display surface of a watch dial. The analog watch further comprises a fiber optic image guide having a entrance window and an exit window. The exit window defines an outer surface. The analog watch further comprises a watch case connected to the watch dial and connected to the fiber optic image guide. The watch case retains the watch dial and the fiber optic image guide in positions such that the entrance window of the fiber optic image guide is optically coupled to the external display surface of the watch dial.

It should be understood that numerous refinements of all of the above discussed embodiments are contemplated as within the scope of the invention. For example, the external display surface of the information display could be in direct contact with the bottom surface of the fiber optic image guide. Alternatively, there could exist a gap between the external display surface and the bottom surface of the fiber optic image guide. The cavity defined between these two surfaces might merely be occupied with air, or could be filled at least in part with some index matching material.

As already discussed, a wide variety of configurations and/or shapes of the top surface of the fiber optic image guide are contemplated as within the scope of the invention. The top surface preferably does not define a single plane, and may be curved, define more than one plane, define a logo, etc. The top surface of the fiber optic image guide could be coated. The fiber optic image guide may be tapered to provide magnification. The fiber optic image guide may comprise a plurality of fibers that are fused together or fibers simply packed tightly together to provide an effectively fused surface. Alternatively, the fiber optic image guide may include a plurality of fibers that are fused together at the ends, but include an intermediate flexible region wherein the optical fibers are not fused together. The fibers of the fiber optic image guide could be effectively fused together using either heat and pressure, an adhesive between the fibers, tight packing of the fibers within some construction, or extruding all of the fibers together at one time as one coherent bundle. The fibers of the fiber optic image guide may be manufactured from glass or plastic, such as acrylic or polystyrene. The fibers may have, for example, a round, square, or rectangular cross-section.

With respect to the information display, it should already be clear that a wide variety of display technologies are contemplated as within the scope of the invention. The information display could be a liquid crystal display such as a twisted nematic display, super twisted, or active matrix. Such liquid crystal displays might include glass or polymer substrates. Alternatively, the information display could be an organic light emitting diode display. The information display may be a reflective, transflective, or emissive display. The information display might include a rear backlight or frontlight utilizing a light emitting diode or electroluminescent. These and other refinements known to those of skill in the art based on the description contained herein are contemplated as within the scope of the invention.

The disclosure herein relates to various uses of fiber optic image guides that include, but are not limited to, completely fused or fused only on input and output surfaces and flexible therebetween, or tapers coupled to the top surface of information displays and having an outer surface of the image guide to affect a design differentiation versus the conventional planar, two dimensional visual appearance of said underlying information displays. The disclosure herein also discusses the different ways the input image surface can be optically coupled to an information display, or specifically a reflective twisted nematic or super twisted nematic liquid crystal display, or emissive display such as active matrix or organic light emitting diode. Also disclosed herein are construction techniques of one embodiment in which a fiber optic image guide system replaces the conventional lens cover found on consumer electronics products such as mobile phones, MP3 players, and digital wrist watches. Additional disclosure herein pertains to how the casing design can be integrated and seamless with the non-planar shape of the outer surface of said fiber optic image guide. Additional embodiments illustrate construction techniques for a digital wrist watch utilizing fiber optic image guides and tapers coupled to underlying conventional information displays.

In one embodiment, the present invention involves the use of fiber optic image guides integrated with information displays incorporated in a variety of consumer electronic devices. In one embodiment of the invention, there is disclosed an unconventional, design-oriented presentation of the display information. Such displays include but are not limited to liquid crystal displays of the twisted nematic (TN), super twisted nematic (STN), or active matrix varieties, and organic light emitting displays (OLED).

In one embodiment of the present invention, a fiber optic image guide is integrated with an external display surface of an information display of a consumer electronic device. The top surface of the fiber optic image guide emitting the display information image to the user can be modified in numerous design-centric ways as taught herein. Thus, in one embodiment, the top surface preferably provides an appearance other than a conventional, flat, two dimensional appearance. From an aesthetic perspective the use of a fiber optic image guide in this way provides a touchable image surface whereas users today are generally accustomed to an information display shielded behind several millimeters of a substantially flat, plastic or glass lens cover and a gap between the lens cover and the information display.

In one or more embodiments of the present invention, the display information is actually emitted on the outermost surface of a particular device as is possible with the fiber optic image guide taught herein. In one embodiment, the outermost surface is preferably either non-parallel to the input surface and/or contoured, thus producing an emitted image that is “touchable.” The face of the fiber optic image guide is preferably optically coupled to the external display surface of the information display, or an intermediate transparent optical layer. This optically coupled face of the fiber optic image guide is preferably as uniform and plane flat as possible. However, the outermost face of the fiber optic image guide visible to the user is preferably contoured for either functional or design centric objectives, and preferably at least portions of the surface of the outermost face are not a flat plane image.

In another embodiment of the present invention, there is disclosed a fiber optic image guide that is preferably integrated with an information display to produce an external non-parallel and/or contoured surface. Such a configuration is likely to negatively impact the quality of the image visible such as brightness or off-axis viewing. Sacrifice of some amount of this image quality using a fiber optic image guide in this fashion, however, creates a preferred design representation of the image produced by an information display in a consumer electronic device. Use of a contoured outermost image display surface can have a significant design impact on mobile phones, MP3, digital watches, and numerous other consumer electronic devices that include an information display.

In yet another embodiment of the present invention, there is contemplated the removal of the standard transparent plastic or glass cover present in construction of a consumer electronic device, such as a digital wrist watch, and replacement of the same with an externally “touchable” fiber optic image guide surface. Various refinements of this embodiment might include a variety of design construction elements. For example, in one embodiment the exterior casing of the product might include a non-planar or contoured construction that can follow that of the exterior surface of the fiber optic image guide. This is in contrast to most, if not all, designs in the marketplace today that include casing constructions that are forced to meet and integrate with the flat, two dimensional transparent lens cover placed over the information display.

One or more embodiments of the present invention might be used in wrist watches, particularly digital wrist watches. One feature of interest in such wrist watches is the provision of a minimal amount of water resistance, with most watches possessing water resistance of several atmospheres from 3 ATM, 5 ATM, and as high as 10 ATM. Some embodiments of the present invention discussed herein will include construction techniques for preferably integrating the fiber image guide with the watch case to maintain levels of water resistance. Also discussed herein are embodiments that provide additional protection of the underlying information display by modifications to the external case and/or module design. Aspects of such modifications include designs wherein external pressure on the fiber optic image guide will not or will be less likely to cause breakage of the underlying information display. In one embodiment there will be a small gap between the bottom surface of the fiber optic image guide and the external display surface of the information display. In a further refinement of this embodiment, an index matching material could be placed in the cavity formed by this gap to reduce light refraction at the material interfaces as well as to provide additional protection to the underlying information display.

In one embodiment of the present invention a fiber optic taper is preferably interfaced with the information display to provide some level of magnification or minimization of the display image visible to the user. In such an embodiment the image on the exterior surface of the fiber optic taper is preferably, but not necessarily, a non-planar and/or non-parallel surface with respect to the planar input surface. Those skilled in the art will recognize that numerous module and case constructions are possible in applications of the present invention. In particular, it should be noted that the actual information display contained therein could be significantly reduced in size, while the external image visible to the user remains the same size. Alternatively, the actual information display might remain the current size, but the external image size could be enlarged to assist, for example, the visually impaired. It will be understood by those of ordinary skill in the art that the designs and methods of the present invention, particularly those pertaining to new module and case construction techniques utilizing either fused or flexible fiber optic image guides and tapers, apply to a wide variety of consumer products and are not limited to wrist watches. Examples include, but are not limited to, consumer product applications such as clocks, mobile phones and MP3 players.

### BRIEF DESCRIPTION OF THE FIGURES

FIG. 1 illustrates a cross-sectional view of a prior art liquid crystal display with fiber optic face plate construction and operation.

FIG. 2A illustrates a cross-sectional view of one embodiment of a fiber optic image guide coupled to an information display, the fiber optic image guide having a top surface that does not define a single plane.

FIG. 2B illustrates a top view of the embodiment of FIG. 2A wherein the top surface of the fiber optic image guide includes a logo.

FIG. 3 illustrates a cross-sectional view of another embodiment of a fiber optic image guide optically coupled to an information display, the fiber optic image guide having a top surface that does not define a single plane.

FIG. 4 illustrates a cross-sectional view of another embodiment of a fiber optic image guide optically coupled to an information display.

FIG. 5 illustrates a cross-sectional view of an embodiment of a tapered fiber optic image guide utilized in a watch case.

FIG. 6 illustrates a cross-sectional view of another embodiment of a tapered fiber optic image guide module construction for a watch illustrating alternative locations for batteries.

FIG. 7 illustrates a cross-sectional view of a conventional prior art digital watch case and module construction.

FIG. 8 illustrates a cross-sectional view of one embodiment of a fiber optic image guide optically coupled to a liquid crystal display in a watch case.

FIG. 9 illustrates a conventional digital watch case construction with a gap between the lens cover and the external display surface of the liquid crystal display.

FIG. 10 illustrates a cross-sectional view of another embodiment of a watch case design and interface to the top surface of a fiber optic image guide.

FIG. 11 illustrates a cross-sectional view of an embodiment of a watch case construction using an embodiment of a fiber optic image guide that includes a non-fused fiber region.

FIGS. 12A-12C illustrate top views of the various orientations possible for an embodiment with a rotatable bezel and fiber optic image guide outer display surface.

FIG. 13 illustrates conventional wrist watch components.

FIG. 14 illustrates a side view of a wrist watch construction including a fiber optic image guide in the band interfaced to a watch case not located on the top of the wrist.

FIG. 15 illustrates a cross-sectional view of common prior art analog watch construction

FIG. 16A illustrates a cross-sectional view of one embodiment of an analog watch case construction that includes a fiber optic image guide.

FIG. 16B illustrates a cross-sectional view of one embodiment of an analog watch case that includes a non-planar watch dial.

FIG. 17 illustrates a cross-sectional view of one embodiment of an analog watch case wherein the bottom external surface of the fiber optic image guide is non-planar.

### DETAILED DESCRIPTION OF THE PREFERRED EMBODIMENTS

It should be understood that the term information display as used herein is intended to encompass a wide variety of displays including, but not limited to, liquid crystal displays (twisted nematic, super twisted, active matrix) organic light emitting diode (OLED) displays, and dynamic scattering liquid crystal displays. The term information display is also intended to encompass other displays in commercial use or under development that could be utilized in one or more embodiments of the present invention, such as liquid crystal on silicon (LCOS). Those skilled in the art will also recognize that most, if not all, of the embodiments disclosed herein involving the use of a fiber optic image guide could be utilized with any of the wide variety of information display technologies just discussed. It should be understood that for both liquid crystal displays and OLEDs, continued development is ongoing to produce displays with plastic or polymer outer substrates. This continued development might permit for either some curvature or flexibility of, for example, the external display surface of the information display. Such curvature or flexibility would further enhance the design possibilities of these information displays as well as their durability. For those applications where the underlying information display has a plastic or flexible surface, it is contemplated as within the scope of the invention that the bottom surface of the fiber optic image guide could also be non-planar to better couple (optically or physically) to the external display surface of the information display.

It should be further understood that the term logo as used herein is intended to encompass a wide variety of forms including, but not limited to, text, marks (such as registered trademarks), pictures, patterns, shapes and other graphic images. In particular, it should be understood that logo encompasses three dimensional shapes as might be used in the present invention. For example, in one embodiment of the present invention the logo is preferably etched into the top surface of the fiber optic image guide. As discussed herein, in some embodiments of the present invention the top surface of the fiber optic image guide does not fall within a single two dimensional plane.

For purposes of the present invention, it should also be understood that the term fiber optic image guide is interpreted in its broadest sense as any material that embodies the essential optical properties of a fiber optic image guide. Thus, the functioning of any particular embodiment of the present invention is not dependent upon the use of, for example, a fused or non-fused bundle of optical fibers. The functioning of any particular embodiment is instead dependent on, for example, the use of any material layer, (such as a fused bundle [i.e., the present invention includes, but is not limited to, a face plate] of optical fibers), that is capable of one or preferably more of the following: total internal reflection, controllable numerical aperture (NA) at input (preferably bottom) and output (preferably top) surfaces, and rotational azimuthal averaging. In particular, the fiber optic image guide shall be capable of translation of the object plane from the rear surface of the layer to the front surface of the layer. It should be apparent to those skilled in the art that these essential optical properties could be imparted to a range of materials, thus producing fiber optic image guide optical equivalents. These could include micro-machined or preformed glass or plastic substrates with a plurality of optical features, a variety of polymer networks containing a duality of materials with differing refractive indices or birefringence produced by physical alignment or stress, or any other approach able to result in a substrate containing a plurality of cylindrical features whose boundaries are defined by a discontinuity of refractive indices.

Moreover, it should also be understood that the fiber optic image guide is generally made up of a number of individual fibers. Thus, on a macro scale, the fiber optic image guide has a bottom surface and a top surface. Each of the top and bottom surfaces is comprised of the individual fiber surfaces. These individual fibers are preferably fused together during the manufacturing process. It should be understood that it is contemplated as within the scope of the invention to utilize a fiber optic image guide wherein the individual fibers are not fused. One possible production technique under consideration is to have a fixed diameter pipe that the fibers are tightly inserted into, but are not required to be fused in order to retain the desired visual effect. The preferred production technique, however, will include fibers fused with heat and possibly pressure. Alternative embodiments contemplated within the scope of the invention include, but are not limited to, fibers preferably fused all at once during extrusion, fusion of the fibers to one another with an adhesive or epoxy, and fibers simply packed tightly together to produce an effective coherent bundle.

With the above in mind, we briefly further note the following additional details with respect to the “macro” surface of the fiber optic image guide. During heat or extrusion fusion of the fibers together, the fibers ideally “mush” together with slight deformation that might affect the visual image slightly. Many commercial applications of fiber optic image guides (such as some medical applications) use small fibers (sub 50 micron diameter) so the packing efficiency (gaps between the fibers) are correspondingly small. It should be understood that smaller fibers are typically more expensive. Thus, commercial applications of embodiments of the present invention in various consumer products will preferably make use of fibers with larger diameters. Embodiments of the present invention preferably include, but are not limited to, fibers having diameters in the range of 100-300 microns. Such diameters are believed to be optically acceptable for consumer products including, but not limited to, watches, MP3 players, and mobile phones. However, it should also be understood that the present invention is not limited to fibers having a diameter of greater than 100 microns. This is particularly true since, as production techniques undergo further development and are refined, costs continue to go down. Thus, smaller diameter fibers, while not presently preferred, are nonetheless a more commercially viable proposition in the future. Moreover, smaller diameter fibers may be necessary in some high resolution displays such as active matrix liquid crystal displays used in mobile phones.

As just noted, cost can be a constraint in the commercial implementation of various embodiments of the present invention. For commercial embodiments in which a liquid crystal display is used and where price is a significant constraint, the cheapest form of liquid crystal display is preferably selected. Reflective or transflective twisted nematic and dynamic scattering liquid crystal displays are generally the cheapest type of liquid crystal display. Consequently, these two displays often find use in watches. The next level up in cost is the super twisted liquid crystal displays followed by active matrix liquid crystal displays. These two types of displays are predominantly used in mobile phones, MP3 players, and other consumer electronic devices. Super twisted liquid crystal displays might be used in watches as well, but the electronics to drive them usually consume a large amount of power (relatively speaking given the types and sizes of batteries used in watches). In the mobile phones category the leading liquid crystal display technology is color active matrix for most phones, and super twisted for the lower priced phones.

In describing the present invention reference will often be made to an external display surface of the information display. Use is made of this terminology instead of top or bottom surface of the information display to avoid confusion as the terms top and bottom surface are used in describing the fiber optic image guide. The term “external display surface” was selected to further reduce confusion as to which surface in a display is that capable of providing information at a display surface. For example, in a twisted nematic liquid crystal display, the image is actually internally generated, typically on the back polarizer surface which does the last absorption of twisted light producing the dark segment. “External display surface” is used to indicate the last material surface of the information display the light is transmitted through on its way toward the fiber optic image guide. Thus, in a conventional twisted nematic display the external display surface would be the top polarizer, while in an organic light emitting diode display the external display surface would be the top glass or plastic substrate. It should also be understood that this term is thus intended to encompass both emissive and reflective (i.e. non-emissive) display technologies.

It should also be understood that, as used herein, the term optically coupled is a subspecies of the more general notion of coupling two optical elements together. To optically couple two optical elements together is intended to encompass those situations wherein a substantial portion of the light exiting the face of the first optical element impinges on a face of the second optical element. As a non-limiting example, the input (bottom) surface of the fiber optic image guide and the external display surface of the information display are preferably optically coupled together. Thus, a substantial portion of the light exiting the external display surface of the information display will impinge upon the bottom surface of the fiber optic image guide.

In some embodiments of the present invention the components that are optically coupled together will directly contact one another. It should be understood that direct contact is intended to encompass those situations wherein the components are retained in contact with one another by an intervening adhesive or epoxy. It should also be understood that it is contemplated as within the scope of the invention that two components that are optically coupled to one another might include an intervening gap between the exit face of the first component and the entrance face of the second component.

Fiber optic image guides (also known as fiber optic image conduits) and tapers are typically coherent bundles used to improve, enhance, magnify, minify, or record an image. They are similar to fiber optic face plates in that the glass or plastic optical fibers are arranged coherently so as to transmit an image from the input plane to the output plane, but are typically thicker than just a couple of millimeters. It should be understood that the more general term fiber optic image guide encompasses the more specific term of fiber optic face plate. It should also be understood that fiber optic image guides may or may not be tapered, depending on the preferred configuration for a given commercial application.

Tapered fiber optic image guides include optical fibers that on one end have a smaller diameter than the diameter of the corresponding optical fiber on the opposite end. When viewing the top surface of a taper which has the larger optical fiber diameters, one will see a magnified image, and inverting the taper orientation will result in a minimization of the output image. Emagin is a company that specializes in organic light emitting displays (OLED) and on their Web site (www.emagin.com) they sell a fiber optic taper product that is designed to interface to the outside top surface of the information display and is used to present a magnified, flat image of the OLED visible to the user. This product uses the taper to allow customers to enlarge the apparent size of the OLED display used in their particular product application.

Fiber optic image guides are commonly utilized in borescopes, fiberscopes, and endoscopes. In some of these applications the fiber optic image guide is often fused, but can be bent or curved with a minimum loss of the light being transmitted from the input planar surface to the outside planar surface. This allows a user to insert the input planar surface into an enclosure such as the inside of a motor or a wall and visually inspect the surface area therein. Fiber optic image guides can also have the fibers coherently fused and parallel to each other on both the input and output planar surfaces, while the optical fibers are not fused throughout the length between these surfaces. This allows an observable image guide that can be flexible, and articulated allowing the user better viewing in the desired application. Often an objective lens, effectively a magnifying lens, is coupled to the output planar surface of the fiber optic image guide to enlarge the image visible to the user.

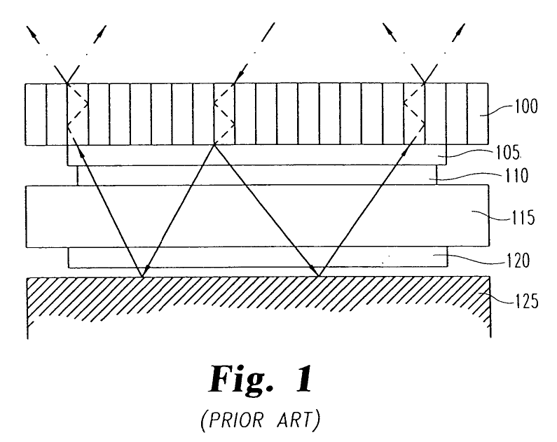

With reference to FIG. 1 there is illustrated a prior art construction of the combination of the fiber optic image guide coupled with a liquid crystal display that utilizes at least one polarizer. As taught in U.S. Pat. No. 5,035,490 to Hubby, Jr., the objective is to use a fiber optic image guide to improve the image quality of the liquid crystal display. In the disclosed embodiment the fiber optic faceplate 100 effectively replaces the top glass substrate and sandwiches the polarizer 105 and liquid crystal material 110 between the other glass substrate 115 and rear polarizer 120, and final specular reflector 125. This is a fairly conventional liquid crystal display construction except for the utilization of the fiber optic waveguide 100.

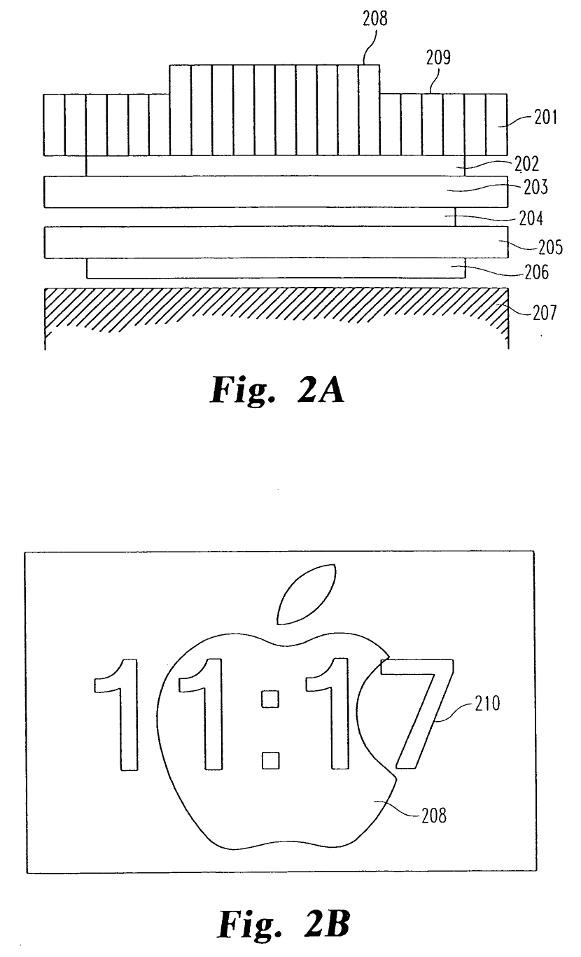

With reference to FIG. 2A, there is illustrated a cross-sectional view of a fiber optic image guide 201 on the top surface of a conventional reflective liquid crystal display. One aspect of one embodiment of the present invention is that, unlike prior art that presents the same planar image of the liquid crystal display on the outer surface of the fiber optic image guide 201, a specific area of the fiber optic image guide 201 is made to have an upper planar surface 208 spaced apart from the lower top planar surface 209. This height differential can be seen when viewed off axis or from the side as illustrated in the cross-sectional view of FIG. 2A. Thus, one embodiment of the present invention permits consumers to see and touch, as it lies on the exterior of product, the top surface of the fiber optic image guide.

In one preferred embodiment, a consumer electronic device includes a fiber optic image guide whose top surface defines at least a portion of a logo, such as a brand or trademark, on the display. It should be understood that for some consumers, the display is the focal point of the consumer electronic device. Despite the presence of the logo on the display, the image displayed will preferably not be significantly negatively impacted. Those skilled in the art will understand that other embodiments are contemplated as within the scope of the present invention. For example, rather than an elevated area, the logo might instead be a depression relative to the other planar outer surface of the fiber optic image guide.

FIG. 2B illustrates a top view of the embodiment of the display and fiber optic image guide 201 of FIG. 2A. The top surface of the fiber optic image guide 201 has an elevated planar surface 208 that might be cut into a specific shape. For example, the famous Apple logo indicated in FIG. 2A. It should be understood that when viewed head on to the display as illustrated, there will be minimal negative image effects to the image being depicted by the underlying liquid crystal display. As illustrated in FIG. 2B, the image being depicted by the underlying liquid crystal display is the time information 210. The time information as displayed in this and several figures in this patent application is shown as an integrated font to simplify the figures, rather than being composed of individual pixels as would actually be the case. Those skilled in the art, however, will understand how the electrode surfaces in an underlying information display, such as a liquid crystal display, would consist of graphical, segmented, or dot matrix configuration.

Again referring to FIGS. 2A and 2B, at the edges where the top planar surfaces 208 and 209 are not matched, there will be some negative image effects. Such negative image effects make the elevated surface 208 slightly noticeable to the consumer. This is due, at least in part, to the fact that there will inevitably be plastic optical fibers at the intersection region that may be damaged or non-functional in producing this elevated display area branding effect. Viewed head on these negative image affects will preferably be negligible.

Numerous modifications and treatments might be made to the transmitting fiber to produce a variety of potentially desirable effects. In one preferred embodiment of the invention the top fiber optic image guide surface is accessible and external. Since the image quality is generally dependent on the polish and angular treatment of the optical fiber ends, a protective coating layer may be placed on the external surface. The treatment preferably provides a thin, protective layer to protect the polish, and an end treatment of the glass or plastic fibers that make up the fiber optic image guide or taper, while not significantly decreasing the light transmittance.

Another embodiment might include cutting the fibers at varying angles all differing to present a preferred potentially unique image appearance or all unified in some fashion. In one variation of an embodiment of the present invention, the larger surface area of the (preferably fused) surface of the fiber optic image guide is altered by making (preferably very small) varying cuts to one or several fibers at a time. Such cuts could result in varying acceptance angles for the incident light resulting in portions of the image being visible in one direction, and portions of the image being visible in an entirely different viewing angle. The cuts in the fibers might be at an angle so as to produce an angular viewing cone that is controllable (based on the angle cut of the fiber and the numerical aperture). A variety of impurities or dyes can be added to the optical fibers to produce different colors, fluorescence, luminescence, and other visual effects on the transmitted image. It should be understood that all such variations are contemplated as within the scope of the invention. In particular, such variations are contemplated for use in digital watch applications including, but not limited to, applications wherein colored watch lens covers are used to provide a color tint to the standard black-and-grey twisted nematic liquid crystal displays.

As previously discussed, many of the consumer electronic products as detailed herein are very price sensitive. The price of fiber optic image guides are typically a function of the diameter of the optical fibers used therein. Smaller diameter fibers provide higher resolution, but require many more fibers, and consequently more labor expense for production. One preferred embodiment of the present invention includes producing fiber optic image guides with the largest optical fiber diameter that still provides an acceptable level of image quality for these consumer applications. It is likely that the preferred optical fiber diameter will be in the range of 100 microns to 300 microns. The material composition of the fiber optic image guides can be glass or silica. In one preferred embodiment, however, the optical fiber core is made of plastics including, but not limited to, acrylic (PMMA) or polystyrene to reduce cost. It should be understood that a wide variety of optical fiber combinations of core and cladding material differences could be produced. Such varying combinations are contemplated as within the scope of the invention. The ratio of core to cladding thickness is also preferably optimized to provide an acceptable level of image quality. It is preferred to have the cladding thickness significantly minimized, but at a level that does not allow significant crosstalk or loss of light at the core-cladding interface.

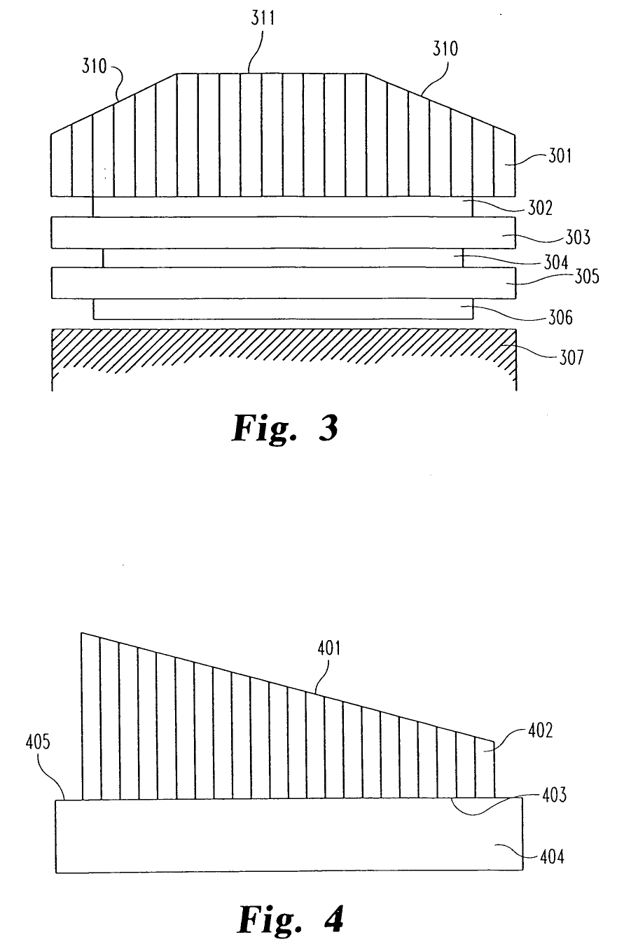

With reference to FIG. 3, we ignore for the moment the fiber optic image guide 301 illustrated therein. FIG. 3 illustrates a cross-sectional view of a conventional structure for a twisted nematic (TN) liquid crystal display (LCD). Such twisted nematic liquid crystal displays are commonly found in digital wrist watches commercially available today. The front polarizer 302 is located on the exterior of the front substrate 303. The front substrate 303 is typically manufactured from glass, but it should be understood that front substrate 303 might also be manufactured from plastic of varying types. On the rear face of the front substrate 303 is a conductive thin film (often indium-tin oxide (ITO) coating), that is used to define the active segments or pixels of the information display. On the interior of the indium-tin oxide coating is a thin polymer alignment layer (commonly polyimide), that is thinly coated and then effectively abrased in one direction to provide a microscopic alignment layer for the liquid crystal material 304 in one direction. These same indium-tin oxide and polyimide layers are also found in the interior of the rear substrate, although the polyimide alignment layer is abrased at an angle of 90 degrees offset from the alignment direction of the polyimide layer found on the interior of the front substrate. In FIG. 3 the indium-tin oxide and polyimide layers are not shown in an attempt to simplify the drawing. The liquid crystal material 304 is thus sandwiched between the front and rear substrates. The spacing between the front and rear substrates is preferably in a range of five to eight microns for a typical twisted nematic display, and an even smaller spacing is generally used for super-twisted nematic (STN) displays. The nature of a liquid crystal is that it behaves like both a liquid at a macroscopic level, but more like a solid crystal with a light transmittance axis at a microscopic level. The liquid crystals are aligned with the direction of both alignment layers which are ninety degrees offset, and the crystalline structure of the fluid between these two layers is effectively twisted resulting in an effective rotation or “twisting” of the light. A rear polarizer 306 and reflector 307 are positioned beneath the rear substrate.

For purposes of illustration only, one mechanism by which a typical reflective twisted nematic liquid crystal display operates is now described. Light is incident on the front polarizer surface. The nature of a polarizer is that it either reflects or absorbs one polarization of light, or effectively 50% of the unpolarized incident light on it. The non-absorbed polarization passes through the glass substrate and various layers until it reaches the liquid crystal fluid which effectively twists the light through its crystalline light transmittance axis so that the polarization of light passes through the crossed polarizer found on the bottom of the rear glass substrate. The light is reflected off the rear reflector and then passes through the optical system and back out. When it is desired to indicate a black segment, pixel, or informational display element, a voltage is applied to the corresponding front (top) and rear (bottom) indium-tin oxide etched areas.

The other unique property of liquid crystals is that they change their molecular alignment when in the presence of an electric field. When the voltage is applied to the indium-tin oxide etched areas the liquid crystal fluid located between those indium-tin oxide layers rotates in an orientation parallel to the electric field, and in this orientation no longer rotates the direction of the incoming polarized light. Therefore the polarized light that passes through the front (top) polarizer is not rotated and instead becomes absorbed by the rear (bottom) polarizer effectively producing a dark or black segment on an otherwise grey display. Those skilled in the art can recognize how the twisted nematic or other liquid crystal display varieties can also be transmissive, or transflective, can have backlights or frontlights, or use new reflective polarizers (from companies such as 3M) versus conventional absorptive polarizers. Those skilled in the art will also recognize how various films or other intervening layers can be used in various locations within the display construction to enhance viewing angle, brightness, or other optical characteristics.

Again with reference to FIG. 3, there is illustrated a cross section of a fiber optic faceplate 301 that is preferably coupled to the top surface layer of the top polarizer 302. The liquid crystal display illustrated in FIG. 3 is preferably a conventional twisted nematic (TN), or super-twisted nematic type of reflective display. Those skilled in the art will recognize that the internal polyimide alignment layer that is used to align the liquid crystals, as well as the indium-tin oxide (ITO) electrode layers are not illustrated in FIG. 3 and other figures herein. Such elements have been omitted in an attempt to simplify the drawings. One difference between this embodiment of the invention and that taught in the prior art is that the fiber optic image guide 301 has an outer surface that is deliberately non-planar shaped (that is to say, it does not define a single [one and only one] plane) and often not parallel to the input surface. The effect of this non-planar shaped outer surface is that the viewing angle and image quality will be degraded to some degree. Those skilled in the art will recognize that the electrode patterns on the underlying liquid crystal display may be modified so that the information it displays coincides with the modifications made to the outer surface of the fiber optic image guide. For example, in FIG. 3 the fiber optic image guide is illustrated as including an angular orientation 310 on either side of a central planar portion 311. The liquid crystal display electrode patterns under these two angular regions could be modified to provide different display information emitted by these angular orientations of the fiber optic image guide. Such modifications could at least in part compensate for the image degradation associated with the shape of the outer surface as well as allow for differing information content to be displayed at these angular orientations.

Those skilled in the art should understand that a LED or electroluminescent backlight could be integrated with the liquid crystal display. The LED or electroluminescent backlight could be located behind the reflector 307 which could be replaced with a transflective surface. Alternatively, the LED or electroluminescent backlight could be located in front of the reflector 307 behind the back polarizer. Those skilled in the art should also understand that, alternatively, a LED frontlight could be used. The LED frontlight could be positioned between the top polarizer 302 and bottom surface of the fiber optic image guide 301.

Using a fiber optic image guide 301 with a non-planar outer surface will degrade the image quality of the underlying liquid crystal display. The quality of one or more of the following characteristics could be degraded: brightness, contrast, ghosting of image, or viewing angle. Some embodiments of the present invention will include various means to minimize the degradation of the image of the underlying display. Varying types of liquid crystal displays ranging from reflective or transflective twisted nematic, or super twisted nematic (low power, and low cost display systems utilized in digital wrist watches, and other consumer products) or emissive active matrix displays (more often found in MP3 players or mobile phones) might be used in the present invention. The substrates and various intermediate materials such as polarizers, retardation films, and enhancement films utilized in such liquid crystal displays are preferably as thin as possible. When made as thin as possible, the input plane of the fiber optic image guide is as close as possible to the layer where the image is formed within the information display. The typical twisted nematic liquid crystal display utilizes a substrate of glass having a thickness in the range of 0.4 mm-0.5 mm. Companies such as SWATCH have commercialized digital watches using substrates as thin as 0.3 mm. It should be understood that the various embodiments of the fiber optic image guides of the present invention can work with glass or plastic substrates of varying thicknesses. However, the focus of the fiber optic image guide is on the immediate surface with which it is in contact. Thus, it is preferable to use glass or plastic substrates as thin as commercially possible.

Those skilled in the art will also know and appreciate how reflective polarizers developed by 3M and sold under the Vikuiti brand could be used in the present invention to replace conventional absorptive polarizers, and how said construction may have to differ slightly versus conventional operation of a liquid crystal display as illustrated in FIG. 3. The use of a fiber optic image guide as taught herein will negatively affect the perceived brightness of the display, and the viewing angle. Additional brightness and viewing angle enhancement films can also be used to optimize and compensate for any optical display qualities lost by use of the fiber optic image guides (including tapered fiber optic image guides) disclosed herein.

With reference to FIG. 4, there is illustrated another embodiment of a fiber optic image guide 402. Fiber optic image guide 402 includes an angled/non-parallel exterior top surface 401 with respect to the bottom planar surface 403 of the fiber optic image guide. The bottom planar surface 403 is optically coupled to the external display surface 405 of the information display 404. Those skilled in the art will recognize that the fiber optic image guide could be either a glass or plastic optical fiber bundle that has been heated and bent or cut with said angular face, as well as other various techniques to produce said angular face for the fiber optic image guide 401. The top non-planar surface 401 of the fiber optic image guide 402 could also be modified in numerous different ways including, but not limited to, curved surfaces or some combination of straight and curved surfaces.

As noted at the beginning of this detailed description of the preferred embodiments, those skilled in the art will also recognize that this embodiment involving the use of a fiber optic image guide 402 to provide, for example, a non-uniform, non-planar image display for design purposes could also be utilized with a wide variety of information display technologies. The fiber optic image guide 402 as taught in this embodiment could be utilized with any such information display technologies. Again, for those applications where the underlying information display has a plastic or flexible surface, the bottom surface of the fiber optic image guide could also be non-planar to better couple (optically and/or physically) to the external display surface, and then still have the non-planar outer surface as illustrated in FIG. 4.

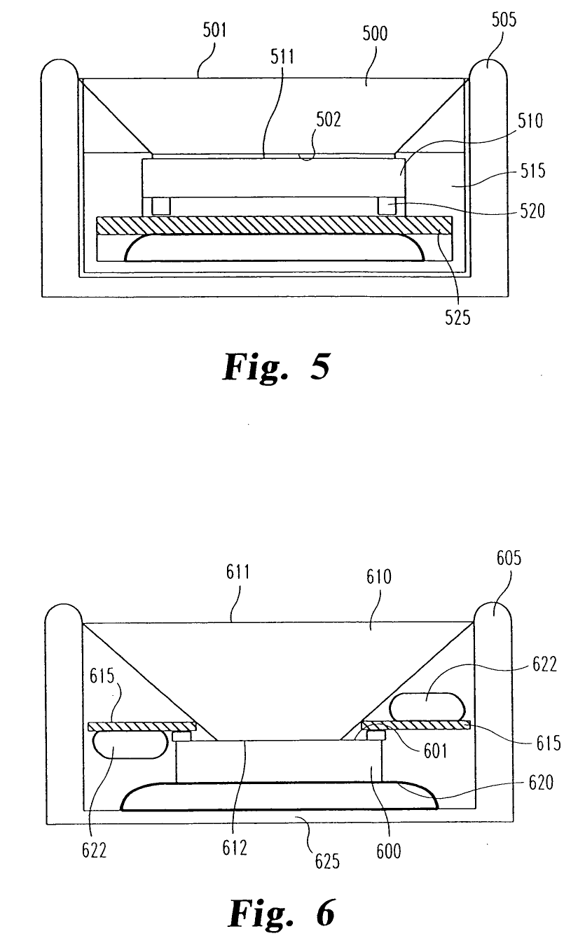

With reference to FIG. 5, there is illustrated a tapered fiber optic image guide incorporated into a watch or other consumer electronic device. Tapered fiber optic image guides generally have fibers of a smaller diameter on one side and those of a larger diameter on the other side. The magnification or demagnification (depending on the orientation of the taper) is a function of the two different optical fiber diameters. FIG. 5 illustrates the incorporation of tapered fiber optic image guide 500 in a watch case 505, preferably replacing the conventional lens cover. The illustrated embodiment makes the information display appear to have a much larger visible area. For example, a typical digital watch features a liquid crystal display 510 that includes an outer non-active area of approximately a couple of millimeters. Additional non-active display area is also created by the plastic module 515 that retains the liquid crystal display 510 in place with the zebra connectors 520 and printed circuit board 525, and then the final watch case also having several millimeters of wall thickness. The resulting effect is that the actual active display area of the display is a much smaller percentage of the overall face of the watch case and outer diameter. Using a tapered fiber optic image guide in a digital watch increases the effective visible area of the display as a percentage of the overall size of the outer watch case.

In many watches the liquid crystal display size is maximized in proportion to the overall watch case. As illustrated in FIG. 5, the top surface 501 of the tapered fiber optic image guide 500 is the display surface, and is maximized in proportion to the watch case. The input surface 502 of the fiber optic image guide 500 is smaller in proportion to the magnification ratio. The liquid crystal display need only be the same size as the input surface of the taper. Consequently, the external display surface 511 of liquid crystal display 510 can be a smaller display than what would typically be found in a similar watch. The degree of magnification required by use of the fiber optic image guide 500 is often a function of the length of fiber, and in a typical watch application the watch case itself usually has a thickness of 8 millimeters to 13 millimeters on average. Persons of ordinary skill in the art should understand that cases may range from as little as a few millimeters thick to as large as 15 millimeters to 16 millimeters. Thus, in a standard digital watch application the tapered fiber optic image guide will be approximately 4-10 millimeters thick on average. In such a small optical fiber length, however, it becomes more difficult to achieve any significant magnification. The degree of magnification effect in most applications will be less than two times. It should be understood that any amount of magnification might be desirable. However, those skilled in the art will recognize that in other consumer products the size requirements are not as stringent as in digital wrist watches, and resulting longer optical fiber length might produce higher magnification effects.

With reference to FIG. 6, there is illustrated some of the new module construction that is possible if the liquid crystal display 600 can be made smaller. This may provide additional space within the watch case. In one embodiment of watch case 605, the bottom surface 612 of the tapered fiber optic image guide 610 is optically coupled with at least a substantial portion of the active area of the top surface 601 of the information display 600. FIG. 6 thus illustrates how the top surface 611 of the tapered fiber optic image guide 610 fits directly in the watch case, thereby enlarging the active area of a typical liquid crystal display. Thus, the non-active areas of the display as well as the non-active areas of the surrounding module are not visible.

In this embodiment the printed circuit board 615 is preferably located above the liquid crystal display 600. It should be understood that printed circuit board 615 could be made in two separate boards or even a board with a hole in it that could go around the taper itself. The power source could still be one larger battery 620 behind the liquid crystal display 600 as is shown, and still accessible by opening the caseback 625. Alternatively, one or more smaller batteries 622 could be used, preferably being placed in the same plane as the liquid crystal display in the space left by using a smaller liquid crystal display.

The module housing is not shown in this figure, but would still be expected to be utilized in most applications. It should be understood that as manufacturers begin using liquid crystal display and other information displays that include non-glass substrates, the manufacturer may choose to use a heat-seal connection between the display and the printed circuit board. When producing digital watches with an underlying display that does not have glass substrates, and in rare cases for glass liquid crystal displays, the manufacturer may build the inside of the watch case so as to eliminate the need for any separate module housing.

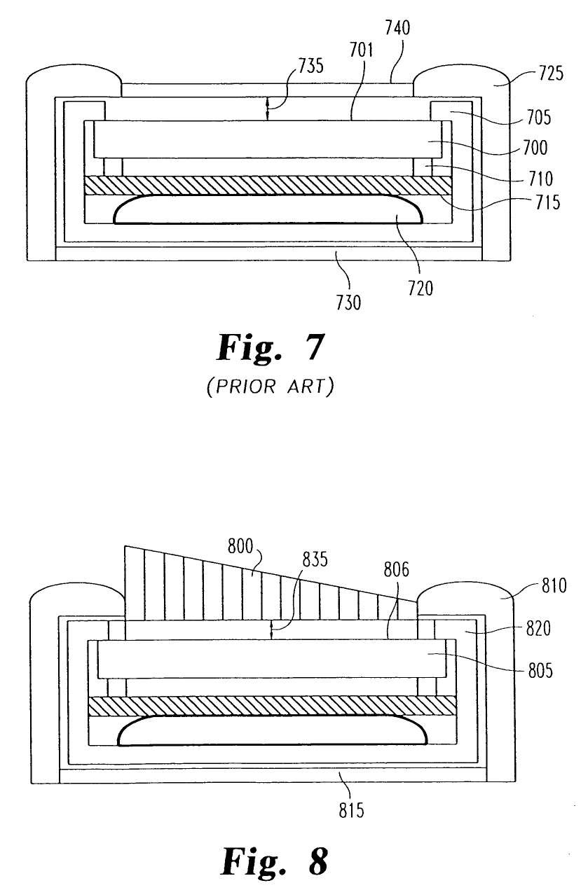

With reference to FIG. 7, there is illustrated a typical prior art construction for a digital watch. One design consideration for a watch case is that it preferably provides some level of water resistance (often up to 3 ATM, 5 ATM, or even 10 ATM). Few commercialized watches lack this basic level of water resistance to protect the internal electronics from sweat and water. Such water resistance is also preferred for coping with situations such as the injection of the watch located on the user's wrist into a body of water such as a sink, or when swimming. Although watches typically have very high ATM water resistance, this is not so much a protection to the actual depth of water the user will descend to while wearing the watch, but the potential water pressure incident on the watch. For example, although a user may only descend to 10 feet into a pool, the act of diving will put several ATMs of pressure on the watch.

The internal design of a typical digital watch comprises a module that includes a liquid crystal display assembly 700. Liquid crystal display assembly 700 is often a reflective or transflective twisted nematic or super twisted nematic display, which may also have an electroluminescent or LED backlight. Standard elements of a liquid crystal display assembly such as glass or plastic substrates, polarizers, indium-tin oxide electrode layers, and alignment layers have been omitted for simplification of this and other liquid crystal display drawings. The liquid crystal display assembly is preferably secured into the (preferably plastic) module housing 705 in such a way that the liquid crystal display is pressed down on zebra connectors 710. Zebra connectors 710 connect the indium-tin oxide contacts on the glass or plastic liquid crystal display substrates and the contacts on the printed circuit board 715. The printed circuit board 715 has the various electronic components and microcontroller unit found on top and/or bottom of the printed circuit board. Printed circuit board 715 draws power from its connection to the battery 720. In the production process of a digital watch this assembled module is then placed into a watch case 725 and the caseback 730 is put on. It is the careful construction of the watch case 725, lens cover 740, and caseback 730 along with the use of various sealants in key interfaces, such as push buttons, that produces a watch case 725 possessing some level of water resistance.

The typical liquid crystal display utilized in digital watches today has glass substrates. Thus, a gap 735 is deliberately put between the lens cover 740 and the top surface 701 of liquid crystal display 700. Consequently, even when maximum pressure is put on the lens cover 740, it will still not deform across the gap 735 such that enough (or any) pressure will be placed on the glass substrates of the liquid crystal display 700 that could break them. One design consideration in existing digital watches is that the entire watch case consisting of a lens cover 740, watch case 725, and caseback 730 form a hermetic seal in all areas. Thus, the watch will possess some degree of water resistance, which is not typically found in most other consumer electronics products. Another consideration is the presence of an air gap (between the lens cover 740 and the top surface 701 of the liquid crystal display 700) to prevent display breakage when significant force is applied to the outer lens cover 740.

With reference to FIG. 8, there is illustrated an embodiment of the present invention of a digital watch construction that includes a fiber optic image guide 800 that replaces the typical lens cover. The fiber optic image guide 800 is optically coupled to the underlying information display 805. Information display 805 is preferably a liquid crystal display. The fiber optic image guide 800 is preferably integrated in such a way with the watch case 810 and caseback 815 to provide an acceptable level of water resistance. Such integration may include, but is not limited to, epoxies or glues, gasketing, or simple tight pressure sealing between the fiber optic image guide and the watch case 810.

In another embodiment of the present invention, the module housing 820 is extended and reinforced in such a way that any pressure applied to the fiber optic image guide 800 will preferably not result in pressure being applied to the (preferably liquid crystal display) substrates of information display 805, but rather the module housing 820. Another embodiment, which is not shown, would have a ledge from the watch case 810 extend underneath the fiber optic image guide 800 in such a way that pressure on the fiber optic image guide 800 would apply to said ledge, rather than the face of the information display 805. Although not shown in this figure, other materials may be used at varying locations within the case cavity, effectively acting like shocks to absorb external pressure on the fiber optic image guide. In FIG. 8 a conventional gap 835 exists between the fiber optic image guide 800 and the top surface of the information display 805 that is a function of the expected maximum pressure on the fiber optic image guide 800 and the resulting maximum deformation. In one preferred embodiment the gap 835 is filled with a transmissive filler material such as an epoxy or other transparent binder that assists in protecting the display during compression. The transmissive filler material also can improve the transmittance of light through the entire optical display system by eliminating or minimizing the air-to-plastic or air-to-glass interfaces where a significant percentage of light is lost. The transparent filler material is preferably index matched as closely as possible to the index of refraction of the display substrate material and fiber optic image guide 800 material composition, which is typically plastic or glass silica. For those digital watches that utilize other display technologies or liquid crystal displays with plastic substrates, the construction will be less dependent on protecting the external display surface 806 of information display 805 from external force on the fiber optic image guide 800.

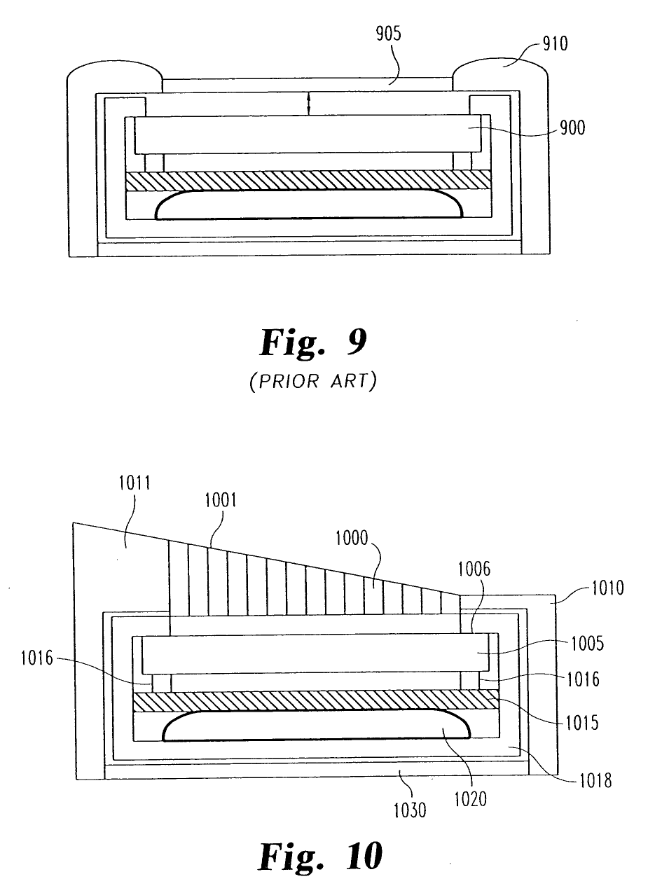

FIG. 9 illustrates a cross-section of a standard digital watch. Because the liquid crystal display 900 lies behind the lens cover 905, every effort is made in the design process to make sure the lens itself remains as flat and as thin as possible to insure the image is as readable as possible. This has resulted in two dimensional digital watch case designs as even the most uniquely shaped watch case 910 must interface with the flat lens cover over the display area.

FIG. 10 illustrates one embodiment of the new case housing's design possibilities using a fiber optic image guide 1000 with a non-parallel and/or non-planar outer surface. In FIG. 10 a fiber optic image guide 1000 is optically coupled to the external display surface 1006 of an information display 1005, preferably a liquid crystal display. It should be understood that the top surface 1001 of fiber optic image guide 1000 can be of varying shapes and contours. In this particular illustration, a portion 1011 of the watch case 1010 may possess a non-conventional structure and integrate itself better aesthetically with the shape of fiber optic image guide 1005. The image itself does not degrade since the fiber optic image guide presents the image transmitted by the optical fibers at the outermost surface. Those skilled in the art of watch design will understand that the present invention might include a wide variety of shapes and contours of the fiber optic image guide 1000, with resulting potential variations in the watch case design. The watch case 1010 is connected to a caseback 1030. Retained within the watch case 1010 and caseback 1030 is a battery 1020 that powers the printed circuit board 1015 to which it is electrically connected. The information display 1005 is retained within a module housing 1018 and is connected to printed circuit board 1015 by zebra connectors 1016.

In the watch industry several years ago Nike™ introduced a line of digital wrist watches that featured the rotation of the liquid crystal display (U.S. design patent No. D394,391) at a slight angle. Thus, when on the wrist the Nike™ design appears to provide a more readable watch dial since the user does not need to rotate their wrist and arm to be in front of their body. The fiber optic image guide as taught herein can be bent or curved or have its outermost surface cut in such a fashion as to provide a curved, angular, non-uniform, or any type of contoured surface. For example, for better readability in a watch application the fiber optic image guide could have an angular shape. Thus, rather than the display image being two dimensional, it could feature varying areas elevated or even angled or rotated toward the user. Consequently, the image information is made more readable to the user even with their wrist and arm orientated on the side of their body. It should be understood that the present invention is not limited to the simple rotation of the display in the same two dimensions. It should further be understood that a wide variety of design configurations are contemplated as falling within the scope of the present invention.

Those skilled in the art of fiber optic image guides are familiar with the process of heating and rotating a fused fiber optic image guide. This may result in an outer surface planar image of the guide that is not parallel and identical in orientation as the image emitted by the display and coupled input surface. Thus, a fiber optic image guide could be used in a watch that has been slightly rotated in one direction or the other much like the Nike display rotation, but now also potentially in three dimensional space. Consequently, the output image display surface of the fiber optic image guide is actually rotated at some angle clockwise or counterclockwise to the orientation of the underlying display.

The use of flexible fiberscopes or endoscopes is quite common in a variety of industrial applications. This type of fiber optic device takes advantage of the image transmittal capabilities of optical fibers. The typical endoscope is used to inspect internal recesses or areas where there is only a very small entry point. The flexible variety of endoscopes use thousands of optical fibers that are fused together on both ends to provide a coherent image bundle. The region of optical fiber between the two fused ends remains non-fused and therefore semi-flexible. This allows some articulation of the image receptive end for easier inspection of some inner cavity. The following illustrated embodiments utilize the basic nature of endoscopes and apply this capability of flexible coherent optical fibers in watch construction embodiments of the present invention.

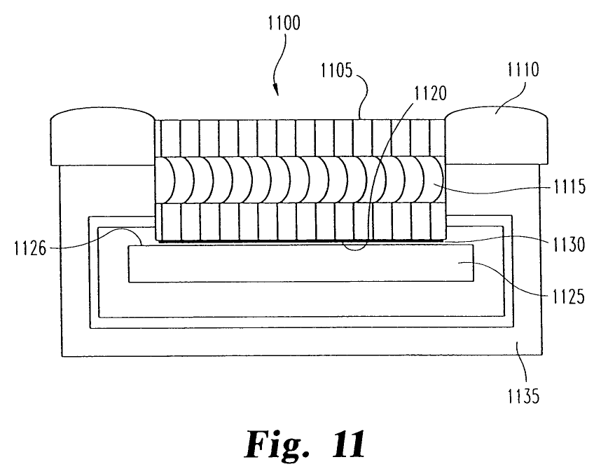

FIG. 11 illustrates a cross-section of a watch case configuration that allows for a rotatable bezel for dynamic rotation of the fiber optic image guide fused top surface 1105. The fused top surface 1105 of the fiber optic image guide 1100 is preferably connected in some fashion to a rotatable bezel 1110. The region of optical fiber 1115 between the input (bottom) and output (top) surfaces of the fiber optic image guide is non-fused and flexible, thus permitting some movement or rotation. Persons of ordinary skill in the art of watches understand how to create rotatable rings on the top of watch cases such as for diver watches, as well as how to produce sealed moveable parts such as bezels and push buttons while still providing the necessary degree of water resistance. Thus, details concerning the same are omitted herein.

The fused bottom surface 1120 is optically coupled to the external display surface 1126 of the information display 1125 as was previously illustrated in earlier figures. The small gap 1130 between the two surfaces could merely be a cavity filled with air or might include some material, preferably index matched to improve light transmittal through the assembly. The fused top surface 1105 of the fiber optic image guide 1100 would then be connected to a rotatable bezel or top ring 1110. Persons of ordinary skill in the art of watches are familiar with the various mechanisms and requirements to produce this type of mechanical rotation and connection of an external rotatable bezel to a watch case 1135. Also in one preferred embodiment the connection of the fiber optic image guide 1100 to the watch case 1135 and rotatable top ring 1110 would be done in such a way to provide some limited level of water resistance as is generally preferred in most watches. The non-fused region of optical fibers 1115 between the two fused surfaces 1105 and 1120 would therefore allow some degree of rotation when the outer bezel 1110 is rotated by the user in either a clockwise or counterclockwise orientation.

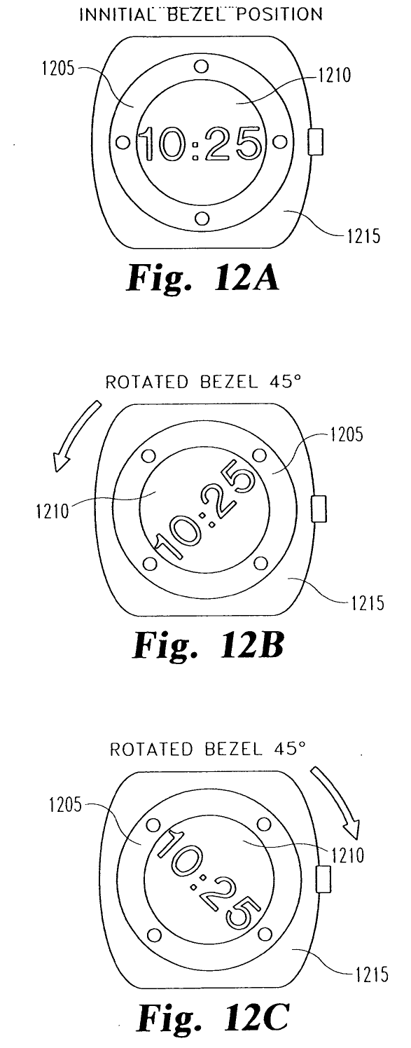

FIG. 12A through FIG. 12C illustrate the usage of a watch case of the construction shown in FIG. 11. The top bezel 1205 has been rotated in either a clockwise (FIG. 12C) or counterclockwise (FIG. 12B) orientation by the user. Thus, the user may dynamically adjust the angle of the information displayed for either improved viewing or simply preferred design aesthetics. FIG. 12A illustrates a frontal, non-rotated view of the watch case with rotatable watch bezel 1205 connected in some fashion to both the fiber optic image guide fused outer surface 1210, and the underlying watch case 1215. The time display is shown in FIG. 12A at standard non-rotated position.

FIG. 12B illustrates the apparent time display visible on the fused outer surface 1210 at forty-five degree counter-clockwise rotation showing resulting time display at this new orientation. The degree of rotation that is possible will be dependent on several variables including: the composition of materials of the optical fiber (with plastic usually being more flexible than glass), the length of area of the non-fused region, force applied, and dimensional specifications of the fiber optic image guide. FIG. 12C illustrates the fused outer surface 1210 image at a forty-five degree clockwise rotation of this fiber optic image guide connected to the rotatable bezel 1205. In this embodiment the length of fiber between the two external fused surfaces would be quite small in a watch application. Those skilled in the art will recognize that this same configuration could be made longer and used in a variety of other consumer electronic display applications.

In typical consumer electronic products ranging from digital watches to mobile phones the display is usually, if not always, centered in the middle of the product. Another embodiment of this invention utilizes a fiber optic image guide that rather than being completely fused together has only the input surface and the output surface fused. In this embodiment the intermediate fiber length remains non-fused and flexible. As just noted, in digital wrist watches or other consumer electronic devices the most common configuration is an information display that is located in the center and most visible place. Thus, in a digital wrist watch, the watch case resides on the top of the user's wrist and the display is centered. In one embodiment of the present invention, a much smaller fiber optic image guide length is used to interface with the top substrate of the display surface. This permits the underlying information display to be positioned in some other location within the module. For example, in a watch with this configuration, the liquid crystal display could be located near the watch clasp typically found in the orientation on the bottom of the user's wrist. The fused input plane of the fiber optic image guide could interface to the top substrate of the display, and then the flexible region of the fiber optic image guide could thread itself through the watch band. Such a configuration thus presents the outer fused image plane in some preferred, contoured form on the user's top of the wrist. This construction permits a greater variety of design options for appearance of the display information on the top of the wrist, where the conventional watch case construction would typically be found. Those of ordinary skill in the art will also recognize that the designs of other consumer electronic products may be similarly modified.

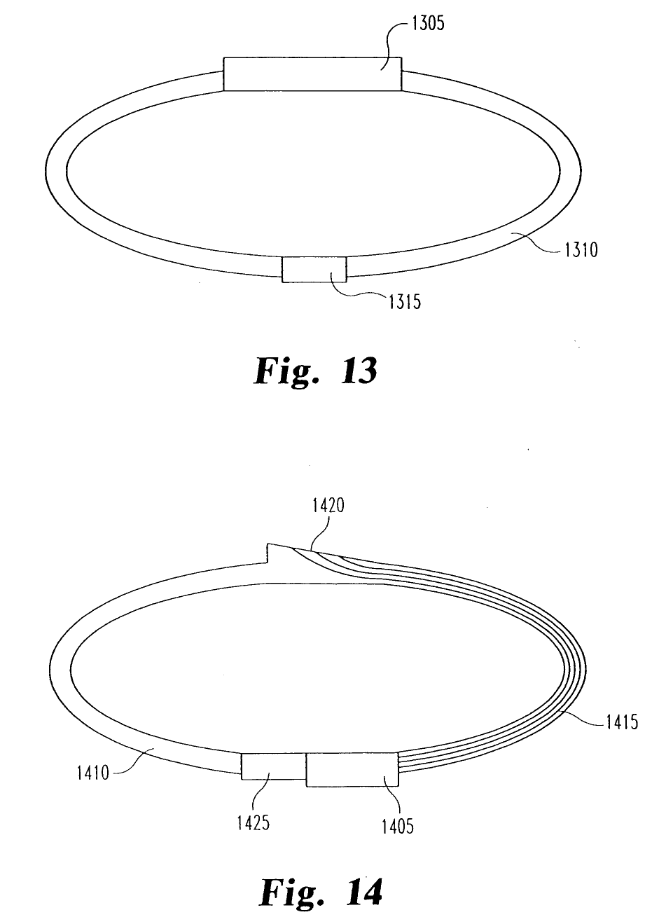

FIG. 13 illustrates the nearly universal standard watch construction common today. Most watches consist of a watch case 1305 that consists of either digital movement with a liquid crystal display or an analog watch movement that is either quartz or mechanically driven. The watch case is visible on the top of the user's wrist and the watch bands 1310 connect to both sides of the watch case and wrap around the wearer's wrist to secure to each other on the underneath of the wrist by use of a variety of different clasp 1315 mechanisms. An embodiment of this invention involves the use of fiber optics in such a way to allow for a radical transformation of the typical watch construction using fiber optic image guides within the watch band.

FIG. 14 illustrates a watch construction where the watch case 1405 that comprises the electronics, battery, and information display is located on the backside of the watch itself. The non-fused fiber optic image guide 1415 would be optically coupled to the information display in the watch case 1405 and extend through the watch band 1410. Those of ordinary skill in the art will understand that a wide variety of methodologies are contemplated within the scope of the invention by which the fiber optic fused input surface is interfaced with the information display found within the watch case construction 1405. The fiber optic image guide 1415 would wrap around one side of the wrist and the fused outer surface 1420 of the fiber optic image guide would display the information, preferably being on the top of the watch and in an orientation that makes it highly visible to the user. In this particular drawing the fused outer surface 1420 is illustrated with an angular display surface. It should be understood, however, that a wide variety of surfaces are contemplated as within the scope of the present invention. In some embodiments an objective magnification lens could be integrated on the top of fused outer surface 1420, as is commonly done with various endoscopes, or the fused outer surface of the image guide could be tapered to provide a magnification of the final image. The fiber optic image guide 1415 that is found within one of the watch bands could have the individual optical fibers fused together providing limited flexibility, or non-fused with only the two outer surfaces fused. Also the fiber optic image guide 1415, and resulting fused outer surface 1420 could be exposed and bare to the user. However, the fiber optic image guide 1415 and outer surface 1420 are preferably protected and surrounded with some typical watch band material. Suitable materials include, but are not limited to, polyurethane (PU), silicone, leather, or even a metal bracelet depending on design considerations such as overall design effect, comfort, and price. The clasp mechanism 1425 used to connect the two watch bands together could be located on the back of the watch in close proximity of the watch case 1405. Alternatively, the clasp mechanism 1425 could be positioned in any location through the elliptical cross section of the watch construction.

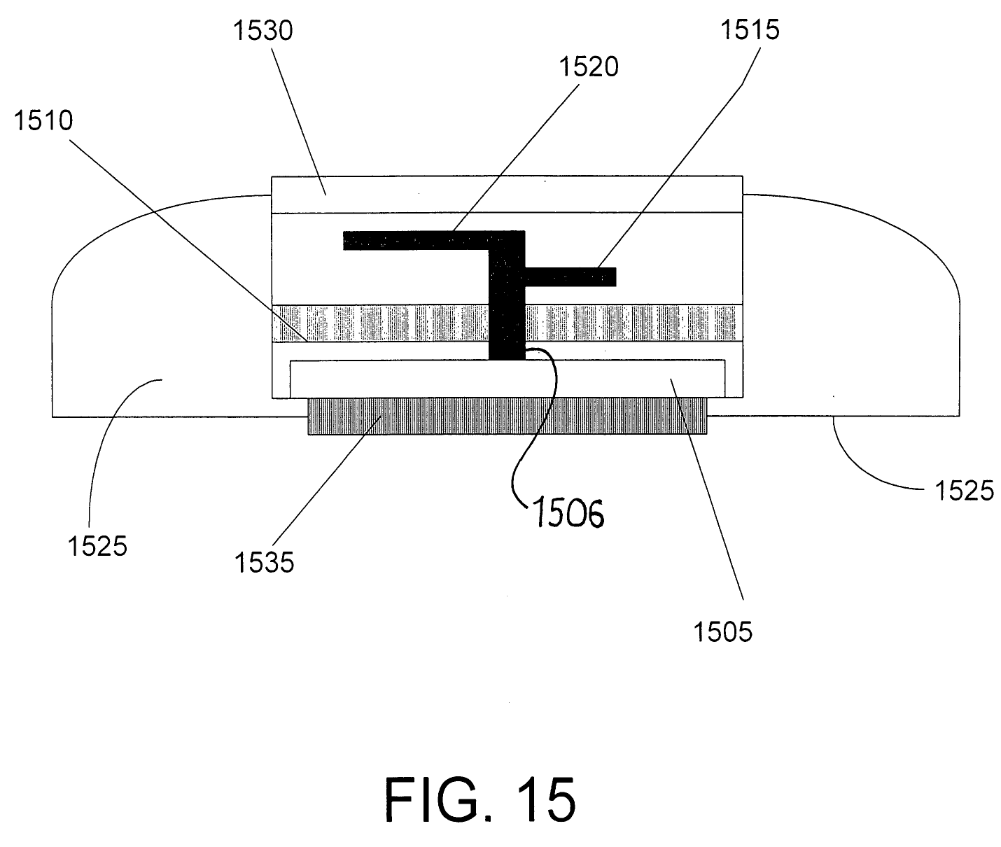

FIG. 15 illustrates one embodiment of the standard elements that are used in the construction of a typical analog watch. An analog watch is defined by its analog movement 1505, which may be quartz or mechanical in mechanism for keeping time. The analog watch movement may also be powered by battery, or stored energy generated by movement of watch on wrist, often referred to as an automatic movement, or winding, to name some of the most popular analog movement powering techniques. The movement is preferably positioned beneath the watch dial 1510. In that scenario, the watch dial 1510 has a hole through its center to allow the stem 1506 of the analog movement 1505 to pass through, and has movement hands, 1515 and 1520, attached thereon. Upon the watch dial 1510 there are a wide variety of types of indicators, ranging from arabic numerals to roman numerals or simply bars at the standard positions for the hours of time, preferably ranging from 1 through 12. It is also upon the watch dial 1510 that adornments ranging from gold, silver, diamonds, or graphics are often placed, printed, or etched on the watch dial to provide increased aesthetic value or an otherwise desired product design for the consumer.

As previously described, the movement hands, 1515 and 1520, are attached to the stem 1506 of the analog movement 1505. Stem 1506 protrudes through the hole in the watch dial 1510. The position of movement hands 1515 and 1520 with respect to the indicators located on the watch dial 1510 is what effectively allows the user to read the time. In FIG. 15 the hour hand 1515, typically the smallest hand shown, and minute hand 1520 are illustrated, and often a second hand (not shown in this figure) is used as well.

A watch case 1525 preferably encases all of these components to protect them, seal the overall unit with some desired level of water resistance, as well as connect to watch bands to hold the watch case 1525 on the user's wrist. A transparent protective lens cover 1530 is also preferably used. Lens cover 1530 may be affixed to the watch case 1525 above the movement hands so as to provide increased viewability of the indicated time and preferably ensures the necessary ATM water protection. Lens cover 1530 is also preferably spaced apart above the movement hands so that any pressure resulting in deformation of the lens cover would preferably not result in contact with the movement hands. It should be understood by those of ordinary skill in the art that lens covers 1530 may be manufactured out of a wide variety of materials, but are typically made from mineral glass or acrylic plastic. The bottom of the watch case 1525 is a caseback 1535 that encloses the components inside, and preferably creates a seal with the watch case 1525 to provide the desired level of water protection.

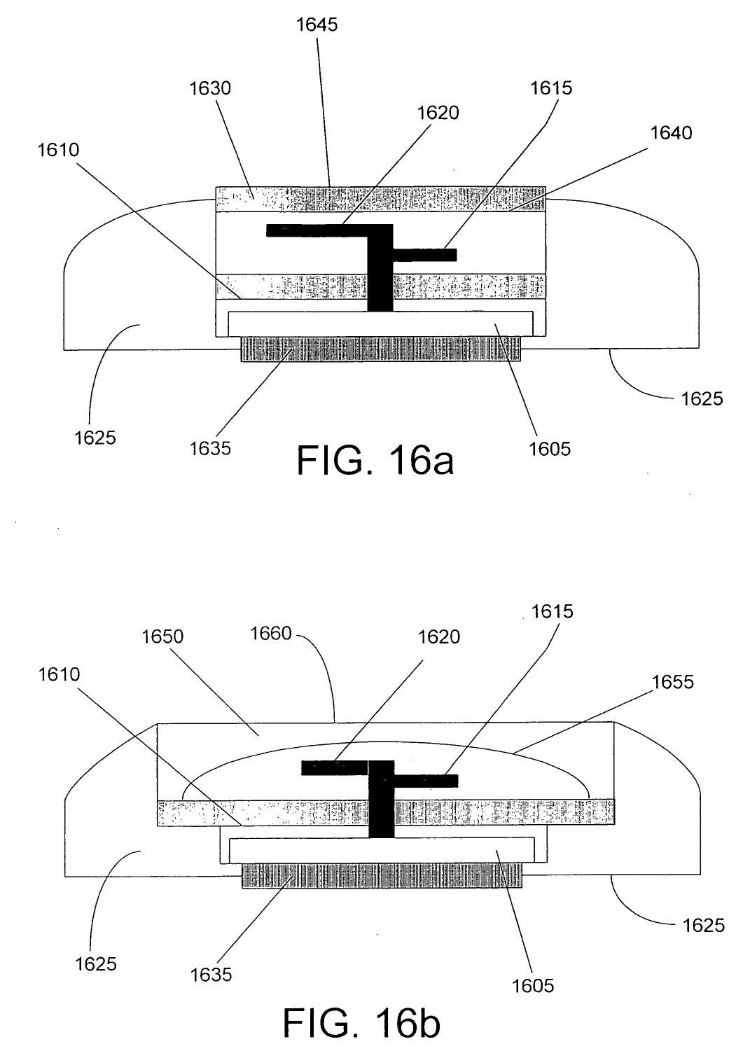

Another embodiment of the present invention includes the use of a fiber optic image guide in place of the lens cover in an analog watch. FIG. 16a illustrates an embodiment of an analog watch wherein a fiber optic image guide 1630 replaces the typical transparent lens cover that is used. A typical lens cover only operates to be highly transmissive and protective. The fiber optic image guide 1630 used as a cover may be used to provide additional optical effects to the observed image. Consumers have become accustomed to the standard visual effect for a watch dial 1610 in that the watch hands 1615 and 1620 are perceived to be below the lens cover. In contrast, use of fiber optic image guide 1630 effectively makes it appear that this information is transmitted from the top surface of the fiber optic image guide 1630 or effectively the outermost external display surface of the watch itself. Additional optical effects that can be produced by the fiber optic image guide 1630 include, but are not limited to, enlarging or minimizing the transmitted image depending on the orientation of an image guide taper, adding color, fluorescence, or phosphorescence, some fixed twist or 3D rotation of the viewable image with respect to the user, dynamic rotation of the image by the user when using a fiber optic image guide with some elasticity, or some non-planar shape, design, or effect on the top external surface of the fiber optic image guide.

The image information that is transmitted from the bottom external surface 1640 of the fiber optic image guide 1630 to the top external surface 1645 has an optical quality that is partially dependent on the distance between the information (in this case the watch hands 1615 and 1620 and the watch dial 1610) that is to be transmitted and visible on the top external surface 1645. The greater the distance between the bottom external surface 1640 of the fiber optic image guide 1630 and image information, the more likely the image will appear to lack focus. Therefore, in one preferred embodiment the hand height of the analog movement 1605 is minimized so that the distance between the bottom of the image guide 1640 is 1-3 mm above that of the watch dial 1610. Of course there is some minimum spacing still preferred between the bottom of the external surface 1640 and the hands of the analog movement 1605. Such minimum spacing is preferred so that any external pressure on the fiber optic image guide 1630 acting as the cover will not deform it so much as to actually contact the hands 1615 and 1620. Such contact might result in a loss or inaccuracy of time-keeping. Many manufacturers today such as SWATCH and others feature analog movements 1605 with short hand heights that are only 1-2 mm above the watch dial. A watch case 1625 preferably encases all of the components to protect them, seal the overall unit with some desired level of water resistance, as well as connect to watch bands to hold the watch case 1625 on the user's wrist. The bottom of the watch case 1625 is a caseback 1635 that encloses the components inside, and preferably creates a seal with the watch case 1625 to provide the desired level of water protection.

FIG. 16b illustrates another embodiment with like elements labeled with reference numerals as previously described. In this embodiment the fiber optic image guide 1650 is not planar on both ends. The bottom external surface 1655 of the fiber optic image guide 1650 facing the analog movement 1605 is curved. The objective of this curve is that areas of the fiber optic image guide 1650 outside the area transversed by the hour 1615, minute 1620, or seconds hand (not shown), are preferably closer to the watch dial 1610. Therefore the top external surface 1660 of the image guide of this preferably will provide an image with improved focus.

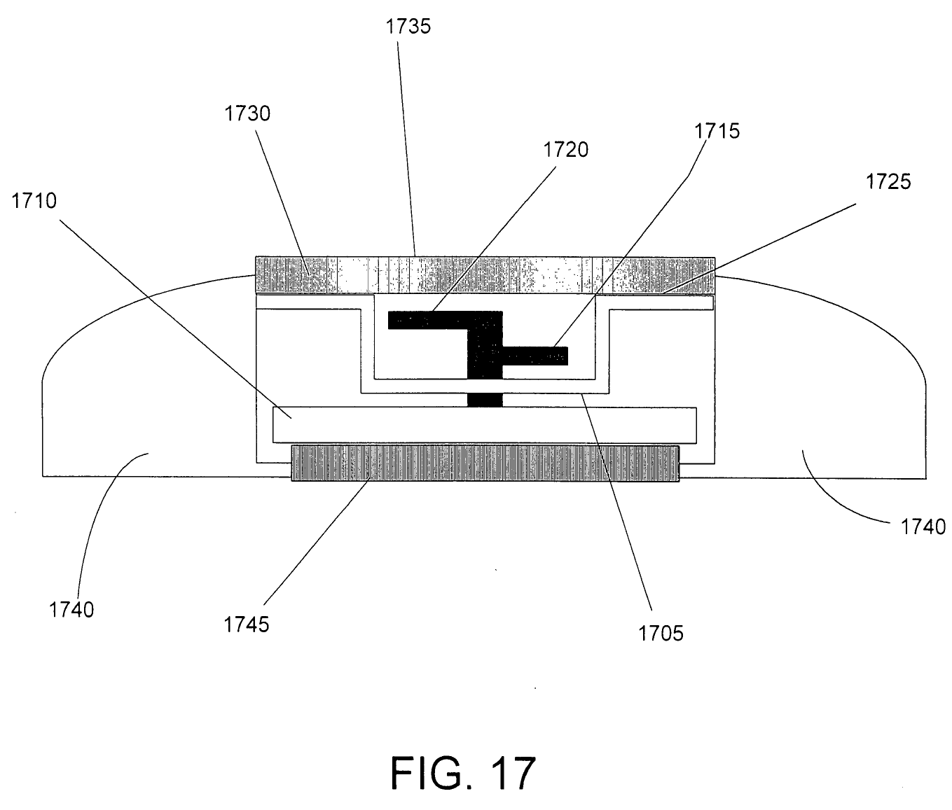

FIG. 17 illustrates another embodiment of the present invention. In this embodiment the watch dial 1705 is preferably shaped like a dish with a hole in it, through which the stem of the analog movement 1710 extends and connects to the hour hand 1715 and minute hand 1720. The region transversed by said hands is the lower shaped region of the dish. The outer face of the watch dial 1705 (where the indices and other graphics are often printed or embossed) may be in actual contact or very close to contact to the bottom external surface 1725 of the fiber optic image guide 1730. Thus, the watch dial 1705 information transmitted to the top external surface 1735 of the fiber optic image guide 1730 in the region outside the area transversed by the movement hands preferably has no significant negative optical effects such as an image that appears to lack proper focus. It is preferred that the hand height of the analog movement 1710 is minimized as much as possible so that the bottom external surface 1725 of the fiber optic image guide 1730 is in as close proximity as possible to both the hour hands 1715 and minute hands 1720, as well as to the dish shaped region of the watch dial 1705 that is located beneath the hands. The fiber optic image guide 1730 is also affixed to the surrounding watch case 1740. Typically watch caseback 1745 is affixed to the back of watch case 1740 to provide some desired level of water resistance.

As previously described, one or more of the embodiments of the present invention (including the just described analog watch embodiments) may include the use of raised, or depressed, logos, graphics, or embossed appearing elements. Other embodiments might include creating raised or depressed graphics, logos, numerals, or other elements on the top external surface 1735 of the fiber optic image guide 1730. Such raised or depressed elements are then correlated to the graphic or watch indicia information printed, embossed, or affixed to the watch dial 1705 itself. For example an arabic numeral “12” might be printed on the watch dial 1705. An embossed or raised region of the fiber optic image guide 1730 shaped and with same dimensions as the underlying printed “12” is then positioned over the printed “12” on the watch dial 1705. Thus, it will appear to the user that the watch indicia appear to actually be affixed to the outside of the watch versus behind a lens cover as found in all watches in the market today.

It should be further understood that the time indicators may, instead of being on the watch dial at all, merely be etched, printed, or otherwise placed on either of the bottom external surface (entrance window) or top external surface (exit window) of the fiber optic image guide. In some such embodiments it is preferred that the movement hands be of a width such that it is clear to which time indicator the movement hands point and/or overlap. For example, it is contemplated as within the scope of the invention that the width of the movement hands may be greater than the width of time indicators (such as bars) that are positioned on the fiber optic image guide. In other embodiments, however, the movement hands do not extend all the way out to the indicators, and in such situations control of the width of the movement hands is of lesser importance.

Various embodiments of the invention have been illustrated and described in detail in the drawings and foregoing description. The same is to be considered illustrative and not restrictive in character, it being understood that only the preferred embodiment has been shown and described and that all changes and modifications that come within the spirit of the invention are desired to be protected.

What is claimed is:

1. An analog watch comprising:
an analog movement capable of providing at least time information indicated by at least two movement hands positioned over a watch dial;
a fiber optic image guide having a first end and a second end, the first end of the fiber optic image guide spaced apart from the movement hands;
a watch case including a wall having an interior surface and an exterior surface, the interior surface of the watch case defining an interior cavity; and,
wherein the analog movement and the watch dial are positioned substantially within the interior cavity.

2. The analog watch of claim 1, wherein the watch case engages at least a portion of the fiber optic image guide so as to provide water resistance

3. The analog watch of claim 2, wherein the watch does not include a lens cover.

4. The analog watch of claim 2, wherein at least a portion of the first end of the fiber optic image guide is optically coupled to at least a portion of the watch dial.

5. The analog watch of claim 2, wherein the first end of the fiber optic image guide is non-planar.

6. The analog watch of claim 5, wherein the first end of the fiber optic image guide is shaped to allow the movement of the hands as well as be in close proximity to the watch dial.

7. The analog watch of claim 2, wherein the watch dial is non-planar and shaped so that portions of the watch dial in a first area transversed by the movement hands are spaced apart further from the first end of the fiber optic image guide than portions of the watch dial in a second area not transversed by the movement hands.

8. The analog watch of claim 2, wherein the watch dial is spaced apart from the first end of the fiber optic image guide.

9. The analog watch of claim 8, wherein the first end of the fiber optic image guide is spaced apart from the movement hands such that pressure on the second end of the fiber optic image guide does not cause the first end to contact the movement hands.

10. The analog watch of claim 1, wherein the first end of the fiber optic image guide is tapered from the first end to the second end.

11. An analog watch comprising:
an analog movement capable of providing at least time information indicated by at least two movement hands positioned over a watch dial;
a fiber optic image guide having a taper extending from a bottom surface to a top surface, the bottom surface of the fiber optic image guide being optically coupled to the watch dial, the taper of the fiber optic image guide extending from the bottom surface to the top surface in such a manner that an image present at the watch dial is magnified for viewing at the top surface of the fiber optic image guide.

12. The watch of claim 11, wherein the top surface of the fiber optic image guide is a planar surface.

13. The watch of claim 11, wherein at least a portion of the watch dial is in direct contact with the bottom surface of the fiber optic image guide.

14. An analog watch comprising:
an analog movement capable of providing at least time information indicated by at least two movement hands positioned over an external display surface of a watch dial;
a fiber optic image guide having a entrance window and an exit window, the exit window defining an outer surface;
a watch case connected to the watch dial and connected to the fiber optic image guide, the watch case retaining the watch dial and the fiber optic image guide in positions such that the entrance window of the fiber optic image guide is optically coupled to the external display surface of the watch dial.

15. The analog watch of claim 14, wherein the entrance window is spaced apart from the watch dial, the entrance window and the external display surface defining a cavity therebetween.

16. The analog watch of claim 14, wherein the outer surface does not lie within a single plane.

17. The analog watch of claim 16, wherein the outer surface defines at least a portion of a logo.

18. The analog watch of claim 16, wherein at least a portion of the outer surface is curved.

19. The analog watch of claim 14, wherein the fiber optic image guide is tapered between the entrance window and the exit window.

20. The analog watch of claim 14, wherein the fiber optic image guide comprises a plurality of fibers that are fused together.
